(19) United States
(12) Patent Application Publication
(10) Pub. No.: US 2023/0289275 A1
(43) Pub. Date: Sep. 14, 2023

(54) SOFTWARE INTELLIGENT OPTIMIZATION SYSTEM

(71) Applicant: MICRO FOCUS LLC, Santa Clara, CA (US)

(72) Inventors: Yong-Chuang Du, Shanghai (CN); Xiaoqin Zhang, Shanghai (CN); Enhui Xin, Shanghai (CN)

(73) Assignee: MICRO FOCUS LLC, Santa Clara, CA (US)

(21) Appl. No.: 17/692,558

(22) Filed: Mar. 11, 2022

(51) Int. Cl. G06F 11/34; G06F 11/30; G06N 3/10

(52) U.S. Cl. CPC G06F 11/3428; G06F 11/3051; G06N 3/10

(57) ABSTRACT

Software applications may be installed on a variety of platforms and/or process a variety of data or data in a variety of structures. As a result, optimizing a system to maximize performance often depends on a specific utilization and the specific data being processed. Systems and methods are provided herein to compare the performance of one processing logic, often a live or production environment to a test environment that varies the performance parameters. The variations may be provided by a machine learning algorithm, such as neural network, and produce an improved set of parameters that may then be applied to the production environment.

### FIELD OF THE DISCLOSURE

The invention relates generally to systems and methods for improving performance of a system and particularly to configuring the system to improve performance given the specific data being processed by a software application.

### BACKGROUND

A software system has various configuration parameters, such as the default maximum number of connections in the database connection pool, the effective time of a single database connection, the effective time of a single client session, the time and frequency of clearing invalid session records, the upper limit of data for a single client operation, the time and frequency of scanning and cleaning up dirty data, the time and frequency of cleaning up temporary data and useless objects, adapting different algorithm logic for different data levels, and so on. These configuration parameters affect the performance of the system and, as such, we need to assign them reasonable values. But what value is considered reasonable? Different customers have different data which can be dynamic, even for the same customer. The usage habits of various customers as well as the server configuration are all different. Therefore, a unified factory setting for these configuration parameters cannot obtain the optimal performance of the system.

### SUMMARY

For certain software applications, testing every possible combination of software parameter values, such as those that configure the operation of the software and/or hardware executing the software, would take an excessively long period of time, even on the fastest computing platforms, because it would produce a very large set of tests. In addition, the way a particular customer utilizes the software application may make one parameter value ideal, whereas that same setting is less than optimal, or even detrimental, to the particular usage of the software application by a different customer. For example, one customer may have a large number of database operations and relatively few messages communicated between systems, whereas just the opposite may be true for another customer. In another example, buffering data, such as emails and text messages, may require a very low amount of system resources and time to read and write the buffers, whereas large datasets or lengthy, high-resolution videos may require substantial resources for the software to perform the same operations. Similarly, buffering a large number of transactions before writing the buffer to a database has different performance impacts if the transactions are small data structures (e.g., text messages) versus large data structures (e.g., video files, large data sets, etc.). Therefore, what is optimal may vary from customer-to-customer, between a first and second dataset, or when a system's hardware is altered. Accordingly, there is a need to optimize a system executing a software application(s) periodically and/or based upon an event (e.g., adding/removing/reconfiguring hardware in the system, change in the type of data being processed, change in performance objectives, etc.).

These and other needs are addressed by the various embodiments and configurations of the present invention. The present invention can provide a number of advantages depending on the particular configuration. These and other advantages will be apparent from the disclosure of the invention(s) contained herein.

Exemplary aspects are directed to:

A system for automatic configuration optimization, comprising:
a first processing system;
a second processing system;
a configuration component to optimize a software application executing on the first processor system;
the configuration component causes the first processing system and the second processing system to each be provided with the software application and data, the data to be manipulated by each of the first processing system and the second processing system determined by the software application and values for a number of parameter values;
wherein the configuration component provides a first parameter value, of the number of parameter values, to each of the first processing system and second processing system; wherein the first processing system, configured with the first parameter value, executes the software application and, therefrom, provides a first performance indicia to the configuration component;
wherein the second processing system, configured with a second parameter value that is different from the first parameter value, executes the software application and, therefrom, provides a second performance indicia to the configuration component; and wherein the configuration component compares the first performance indicia to the second performance indicia and, upon determining that the second performance indicia indicates a performance improvement, configures the first processing system with the second parameter value.

A method for automatic configuration optimization, comprising:
causing a first processing system and a second processing system to each be provided with a software application and data, the data to be manipulated by each of the first processing system and the second processing system as determined by the software application, wherein each of the first processing system and second processing system comprises a number of parameter values utilized to execute the software application;
configuring the first processing system with a first parameter value of the number of parameter values;
configuring the second processing system with a second parameter value of the number of parameter values that is different from the first parameter value;
executing, the first processing system as configured with the first parameter value and obtaining, as a result, a first performance indicia;
executing, the second processing system as configured with the second parameter value and obtaining, as a result, a second performance indicia;
comparing the first performance indicia to the second performance indicia and, upon determining that the second performance indicia indicates a performance improvement, configuring the first processing system with the second parameter value.

A system, comprising:
means to cause a first processing system and a second processing system to each be provided with a software application and data, the data to be manipulated by each of the first processing system and the second processing system as determined by the software application, wherein each of the first processing system and second processing system comprises a number of parameter values utilized to execute the software application;
means to configure the first processing system with a first parameter value of the number of parameter values;
means to configure the second processing system with a second parameter value of the number of parameter values that is different from the first parameter value;
means to execute, the first processing system as configured with the first parameter value and obtaining, as a result, a first performance indicia;
means to execute, the second processing system as configured with the second parameter value and obtaining, as a result, a second performance indicia;
means to compare the first performance indicia to the second performance indicia and, upon determining that the second performance indicia indicates a performance improvement, configuring the first processing system with the second parameter value.

Any of the above aspects:
Wherein the first processing system comprises a production system and the second processing system comprises a test system.
Wherein the first processing system utilizes the data maintained in a first database and the second processing system utilizes the data maintained in a second database and wherein the first database and the second database are synchronized.
Wherein the first processing system and the second processing system are the same system configured and executed at a first time and a second time, respectively.
Wherein the second parameter value comprises the first parameter value with an alteration comprising a randomly selected modification to at least one of the number of parameter values.
Wherein the configuration component compares the first performance indicia to the second performance indicia and upon determining the second performance indicia indicates the performance improvement, configures the second processing system with an altered configuration.
Wherein the second parameter value comprises the first parameter value with an alteration chosen by a neural network trained to select a change to at least one of the number of parameter values.
Wherein the second parameter value comprises the first parameter value with an alteration chosen by a neural network trained to select changes to at least two of the number of parameter values, wherein a change to only one of the at least two of the number of parameter values does not improve performance of the second processing system.
Wherein the second processing system comprises a plurality of second systems each having dissimilar parameter values from a remainder of the plurality of second systems.
Wherein the configuration component, upon determining a first of the plurality of the second systems provide the second performance indicia indicating the performance improvement over a second of the plurality of second systems, configures the second of the plurality of second systems with parameter values of the first plurality of the second systems with at least one additional alteration to the parameter values.
Wherein the first processing system comprises a production system and the second processing system comprises a test system.
Wherein the first processing system utilizes the data maintained in a first database and the second processing system utilizes the data maintained in a second database and wherein the first database and the second database are synchronized.
Wherein the first processing system and the second processing system are the same system configured and executed at a first time and a second time, respectively.
Wherein the second parameter value comprises the first parameter value with an alteration comprising a randomly selected modification to at least one of the number of parameter values.
Further comprising configuring the second processing system with an altered configuration upon determining the second performance indicia indicates the performance improvement.
Wherein the second parameter value comprises the first parameter value with an alteration chosen by a neural network trained to select a change to at least one of the number of parameter values.
Wherein the second parameter value comprises the first parameter value with an alteration chosen by a neural network trained to select changes to at least two of the number of parameter values, wherein a change to only one of the at least two of the number of parameter values does not improve performance of the second processing system.
Wherein the second processing system comprises a plurality of second systems each having dissimilar parameter values from a remainder of the plurality of second systems.

A system on a chip (SoC) including any one or more of the above embodiments or aspects of the embodiments described herein.

One or more means for performing any one or more of the above embodiments or aspects of the embodiments described herein.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

Any of the above embodiments or aspects, wherein the data storage comprises a non-transitory storage device, which may further comprise at least one of: an on-chip memory within the processor, a register of the processor, an on-board memory co-located on a processing board with the processor, a memory accessible to the processor via a bus, a magnetic media, an optical media, a solid-state media, an input-output buffer, a memory of an input-output component in communication with the processor, a network communication buffer, and a networked component in communication with the processor via a network interface.

It is to be appreciated that any feature described herein can be claimed in combination with any other feature(s) as described herein, regardless of whether the features come from the same described embodiment.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware , an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a system in accordance with embodiments of the present disclosure;

FIG. 2 depicts a process in accordance with embodiments of the present disclosure;

FIG. 3 depicts a process in accordance with embodiments of the present disclosure; and

FIG. 4 depicts a system in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising a numeric reference number, without an alphabetic sub-reference identifier when a sub-reference identifier exists in the figures, when used in the plural, is a reference to any two or more elements with a like reference number. When such a reference is made in the singular form, but without identification of the sub-reference identifier, is a reference to one of the like numbered elements, but without limitation as to the particular one of the elements. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

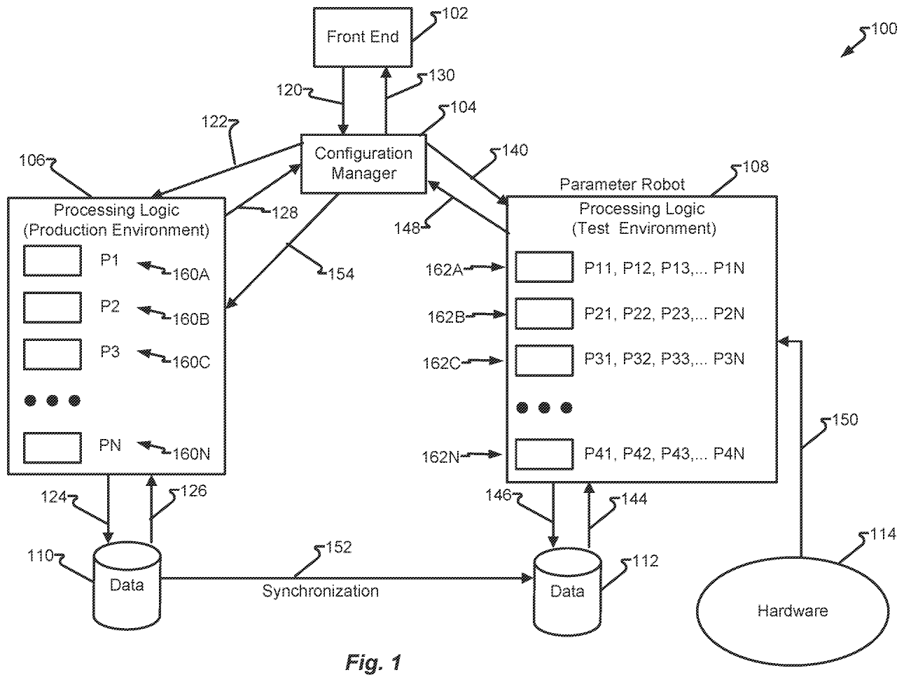

FIG. 1 depicts system 100 in accordance with embodiments of the present disclosure. In one embodiment, front end 102 may comprise an administrative terminal to issue commands and/or requests, collectively referred to as request, to receive data 130. Received data is then utilized for reporting and/or reconfiguration of the production logic of processing logic 106. Systems and operations described herein are unlikely to be portable between different managed systems (e.g., systems having processing logic 106) due to variations in the data processed, hardware utilized, hardware configurations, networking limitations, and other factors. Similarly, a managed system that is changed, such as to utilize different data types, different volumes of data, different hardware/hardware configurations, etc., would likely operate at a less than optimal configuration until, in another embodiment, re-execution of the systems and methods provided herein is performed with the then-current configuration, operations, and data.

In one embodiment, processing logic 106 is a production environment executing data, such as data from database 110, and wherein the results of executing software in a production environment may be utilized for the purpose the software was intended. The performance of processing logic 106 is compared to a second system, such as processing logic 108 executing in a test environment. The test environment executes the same software as that executed in processing logic 106 and data, such as from database 110 and/or data from database 112, that is synchronized, such as in operation 152 with database 110.

The commands and data utilized in processing logic 106 are variously embodied and may include a command to optimize a particular software application and/or receive data indicating the results of the optimization. Front end 102 sends request 120 to configuration manager 104. Configuration manager 104 then forwards request 120 to processing logic 106 as request 122. In another embodiment, configuration manager 104 comprises one or more of data structures, rules, artificial intelligence (e.g., neural network), etc., to convert request 120 into request 122 in a form (e.g., specific parameter value(s), changes to the setting(s), etc.) understandable and/or native to processing logic 106 and/or processing logic 108.

Hardware may be physically provided and configured in processing logic 108 to reflect the hardware as configured in processing logic 106, such as via hardware parameters, as provided by hardware 114. Request 120 is similarly converted into request 140 and provided to processing logic 108 for execution. Processing logic 106 and processing logic 108 are preferably identical in every way (e.g., same software application, same data utilized, same hardware, etc.), except for the parameter values. However, in another embodiment, differences may be accommodated in different ways. For example, if processing logic 106 utilizes lower performance processors that are not available to processing logic 108, then hardware 114 may include or trigger an artificial impedance, such as to make the processors of processing logic 108 operate at the same performance level as the processors of processing logic 106. This artificial slowing may similarly be utilized for other operations (e.g., bandwidth, time to perform read/write operations, etc.). In another embodiment, if a resource, such as a processor, bandwidth, etc., of processing logic 106 operates at a higher performance than the processors available to processing logic 108, then the data results may be artificially adjusted to reflect the anticipated performance as if processing logic 108 utilized the same hardware/hardware configuration. In another embodiment, processing logic 108 may be configured to perform a calibration operation, such as to parallel the data, operations, and hardware of processing logic 106, and any deviations between the operations performed by processing logic 108 and processing logic 106 are noted and optionally utilized to automatically calibrate processing logic 108 and/or the performance data observed by processing logic 108 to ensure processing logic 106 and processing logic 108 are operating identically or, if not, the differences are accounted for in the performance results of the operation of processing logic 108.

Additionally or alternatively, one or both of processing logic 106 and processing logic 108 may comprise one or more parameters, such as parameters 106A-106N and parameters 162A-162N, respectively. Parameters 160A-160N may execute, such as in a production environment, the software application with a particular set of configurations. Parameters 162A-162N of processing logic 108 may each have one or more particular parameter value (e.g., size of a buffer, when to clean-up memory, etc.). For example, parameter 162A may comprise a number of parameter variations (e.g., “P11”, “P12”, “P13”, . . . “P1N”) that each comprise a value for a buffer size. Optionally one of parameters 162A may be the default value utilized by processing logic 106 (e.g., parameter 160A). As will be described in more detail with respect to the embodiments that follow, the values for each parameter 162A-162N and/or the one or more variations within a particular parameter 162 may be determined, in whole or in part, by an artificial intelligence, such as machine learning, which may be embodied as a neural network trained to vary parameter value(s) and/or combinations of parameter values and obtain a resulting performance from processing logic 108 when configured with the variation(s).

Additionally or alternatively, further modifications to the particular parameter values may be carried out to further determine what degree of a change produces a particular change in performance for processing logic 108. For example, processing logic 108 may have parameter 162B configured with a particular setting for a buffer size and execute subsequent tests with modifications to the particular value for the buffer size (e.g., increase the buffer size by 10%, 20%, 30%, etc.) as P21, P22, P23, etc.

Returning to processing logic 106, indicia of performance 128 (e.g., time to complete one or more operations, memory used, processor cycles used, database read/writes, etc.) is returned to configuration manager 104, as well as (if not already known) values for parameters 160A-160N utilized to configure hardware and/or software operations of processing logic 106 in operation 154. Indicia of performance 128 may be an absolute number or a scoring or other representation of performance selected as a proxy for an absolute number. Additionally or alternatively, indicia of performance 128 may be for one metric, a number of metrics, or an aggregation of metrics, and may serve as a baseline performance metric.

Operation 124 comprises a request sent by the business logic from processing logic 106 to a product environment data center and, in return, operation 126 comprises feedback received from the product environment data center. Operations 124 and 126 may occur multiple times.

Operation 152 comprises a synchronization of database 110 to database 112 to ensure that the data in processing logic 108 is consistent with the data of processing logic 106. Operation 146 comprises requests for data from database 112. Operation 144 returns the data requested from database 112 to processing logic 108. As a result of operations 124, 126, 152, 146, and 144, the data utilized in processing logic 106 (e.g., production data) is the same data as that utilized in processing logic 108 (e.g., test data).

Hardware utilized in processing logic 106 and/or processing logic 108 may have device parameters, which are read from hardware 114 repository (e.g., database, server, etc.) in operation 150.

In another embodiment, processing logic 108 comprises or utilizes one or more processors (not shown) executing adaptive machine learning algorithm(s) (e.g., neural network(s)) and are deployed to cause processing logic 108 to learn and optimize parameter(s) and/or parameter combinations that produce the best result from processing logic 108. The best result is variously embodied and may include one or more of the fastest operations, lowest bandwidth, least amount of memory utilized, least amount of data storage utilized, fastest or fewest read/write operations, or lowest power usage, etc.

The machine learning provides the optimized parameter combination to the request and then continues to compare the request time with production environment and feeds it back to the machine learning. The machine learning will repeat the above steps to gradually optimize the request parameter combination based on learned results.

The number of iterations performed by the machine learning may be fixed (e.g., count, iterations in a given amount of time, etc.) or variable. For example, if after several iterations the results from the machine learning algorithm has plateaued the performance of processing logic 108, then the machine learning algorithm may be determined to have identified the optimal set of values for parameters 162A-162N, which is then provided as report 148 to configuration manager 104 and subsequent optimization of processing logic 106. While incrementally changing one or more values for one or more parameters 162A-162N may produce more predicable trends, randomization may occur. For example, changing the size of a memory buffer by increments of a few percentage points may be interspersed with large, random, or pseudo-random changes, changes that may produce large variations, such as to discover non-intuitive values for a parameter or combination of parameters. Randomization may optionally remove a current parameter (e.g., one of parameters 162A-162N) or add a currently unused parameter. When such results are positive (e.g., result in a performance improvement), or neutral, the values may be utilized for more incremental tuning, such as being “upweighted”, so as to be considered more often for use in subsequent operations of the machine learning algorithm. Conversely, if such results are negative (e.g., result in a performance degradation) the parameter value(s) may be excluded from incremental tuning, such as being “downweighed”, and be considered less often, or not at all, for use in subsequent operations of the machine learning algorithm. With the modification applied to the value(s) of parameters 162A-162N and/or to the set itself (addition/deletion of one or more parameters), processing logic 108 requests data in operation 146 and receives data in operation 144 from database 112 and re-executes processing logic 108 to observe the performance thereof and, therefrom, base any subsequent modifications to the value(s) of parameters 162A-162N and/or to the set itself (addition/deletion of one or more parameters).

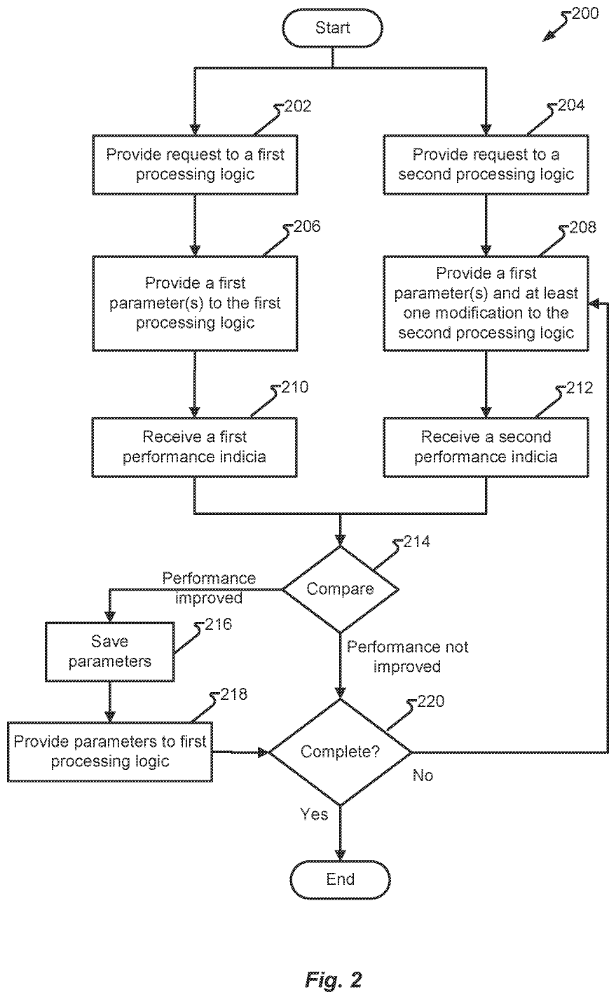

FIG. 2 depicts process 200 in accordance with embodiments of the present disclosure. In one embodiment, process 200 is embodied as machine-readable instructions that, when read by a processor, cause the processor to execute the steps of process 200. The processor may be incorporated into or accessible to a system, such as a component of system 100 (e.g., processing logic 108). It should be appreciated that, in one embodiment, steps 202, 206, and 210 as illustrated are performed in a processing thread in parallel to steps 204, 208, and 212. However, other embodiments are contemplated and may be carried out without departing from the scope of the disclosure. For example, the steps 202, 206, 210, 204, 208, and 212 may be interspersed or overlap. One thread may be performed to completion (i.e., one of the series of steps 202, 206, 210 performed to completion before any one or more steps of the other of the series of steps 204, 208, 212 are initiated), or performed in any order that maintains the relative order of steps 202, 206, and 210 to each other and also maintains the relative order of steps 204, 208, and 212 to each other.

Step 202 and step 204 each provide a request to a processing logic, such as to processing logic 106 and processing logic 108, respectively. The request being to perform an operation utilizing software configured with a set of parameters. The parameters may be applied to the software application itself or hardware utilized by the software application to input, manipulate, or output data. Step 206 provides a first set of parameters to the first processing logic, as well as to the second processing logic in step 208. However, step 208 further modifies at least one parameter, such as by adding a new parameter to the first set of parameters, removing a parameter from the first set of parameters, and/or altering the value of one or more parameters to create a modified set of parameters. The data accessed and manipulated by each of the first and second processing logic is preferably, but not required to be, identical. If not identical, the data should have the same attributes (e.g., size, type, structure, etc.) so as to cause any difference in the performance of the first and second processing logic to be solely the result of the differences in the parameters utilized by the first and second processing logic. However, as described above, differences may be attenuated or otherwise accounted for, such as when the data utilized is not identical or the hardware or other differences exist between the first and second processing systems.

Step 210 produces a first performance indicia of the operations of the first processing logic of the first processing logic executing the software application, configured with the first set of parameters, as it processes the data. Similarly, step 212 produces a second performance logic of the second processing logic executing the software application, configured with the modified set of parameters, as it processes the data. Test 214 compares the first performance indicia to the second performance indicia and, if a performance improvement is determined, step 216 saves the set of parameters and (immediately or at a subsequent time) provides the modified set of parameters to the first processing logic. Processing may then continue to step 220. If test 214 determines the performance of processing logic 108 has not improved, processing continues to test 220. Test 220 determines if the test is complete, such as by determining if the number of iterations of steps 208 and 212 performed is greater than a threshold number of iterations, a time expiration has occurred, performance improvements have plateaued, and or other criteria for termination that, if true, causes process 200 to terminate. If test 220 is determined in the negative, processing may continue back to step 208 wherein the modification is a subsequent or further modification, to the previously modified set of parameters and/or the first set of parameters.

Step 208 may comprise modifying the first set of parameters, or a previously modified set of parameters, by a neural network trained to select parameters, or values thereof, that are designed to improve the performance of processing logic 108 when executing the software application. With each modification, data may be accessed or re-accessed, and step 212 again receives the second performance indicia. Accordingly, test 214 may compare the second performance indicia to the first performance indicia or compare the second performance indicia to a prior performance indicia. As a result, a particular set of modified parameters that does not improve performance may be identified and stored as such and not considered for loading to processing logic 106. However, subsequent modifications to the set of parameters that do improve performance are stored in step 216, such as to provide feedback to processing logic 108 in order to explore further modifications to the previously modified set of parameters and/or maintain the set of parameters to determine if further improvements may be made. As a result, step 218 may be omitted when an improved performance is observed until after test 220 determines the other steps of process 200 are complete, such as to avoid “thrashing” processing logic 106 with a string of updates to the set of parameter settings until a “best” set of parameter settings is determined based on all of the modified set of parameter settings evaluated. It should be appreciated that loading processing logic 106 with the “best” set of parameter settings may be omitted if the first performance indicia is greater than or equal to the corresponding second performance indicia when the “best” set of parameter settings are utilized in processing logic 108.

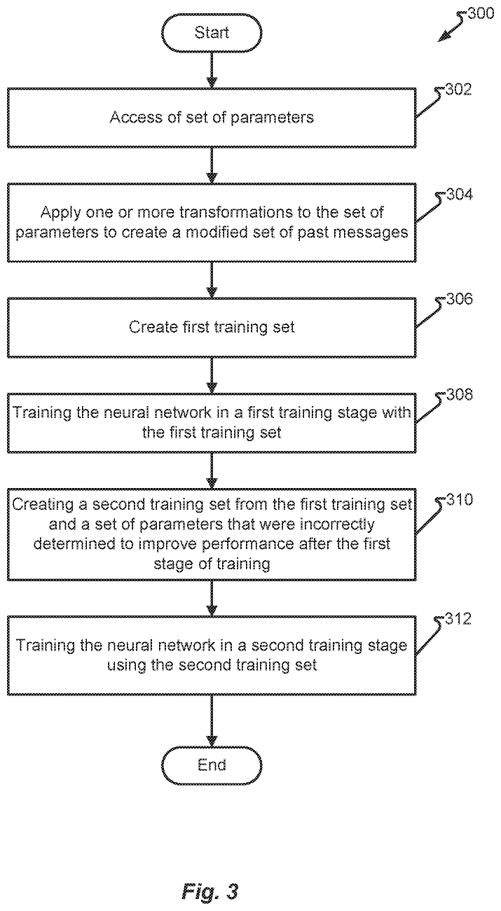

FIG. 3 depicts process 300 in accordance with embodiments of the present disclosure. In one embodiment, process 300 is embodied as machine-readable instructions that, when read by a processor, cause the processor to execute the steps of process 300. Process 300 begins and accesses a set of parameters utilized to configure processing logic 106 and the software and/or hardware utilized by the software, in the performance of processing data.

The operations herein may be performed on one or more processors configured to execute a neural network. Neural networks are known in the art and in one embodiment, self-configures layers of logical nodes having an input and an output. If an output is below a self-determined threshold level, the output is omitted (i.e., the inputs are within the inactive response portion of a scale and provide no output). If the self-determined threshold level is above the threshold, an output is provided (i.e., the inputs are within the active response portion of a scale and provide an output). The particular placement of the active and inactive delineation is provided as a training step or steps. Multiple inputs into a node produce a multi-dimensional plane (e.g., hyperplane) to delineate a combination of inputs that are active or inactive.

Step 304 performs one or more transformations to each of the most relevant customer attributes. In one embodiment, the transformations are determined or selected as likely to improve the performance of a system (e.g., processing logic 108) in the performance of executing a software application manipulating a particular set of data. The transformations include, but are not limited to, one or more of deletion of one or more parameters, adding a new parameter, altering the value of a single parameter, and altering the value of two or more parameters. A modified set of parameters is then created from the most relevant customer attributes as transformed. Step 306 then creates a first training set from the set of parameters and a modified set of parameters. The neural network is then trained with the first training set in a first training stage in step 308.

Step 310 creates a second training set for a second stage of training comprising the first training set and the set of modified parameters that were incorrectly determined to improve performance of processing logic 108 after the first stage of training. Step 312 trains the neural network in the second training stage using the second training set. Once trained, the neural network may be presented with a set of parameters, attributes of utilized hardware 114, data utilized, descriptors of the data utilized, and, therefrom, determine a set of parameters to apply to processing logic 106 to improve, or provide the most improvement, to the performance thereof.

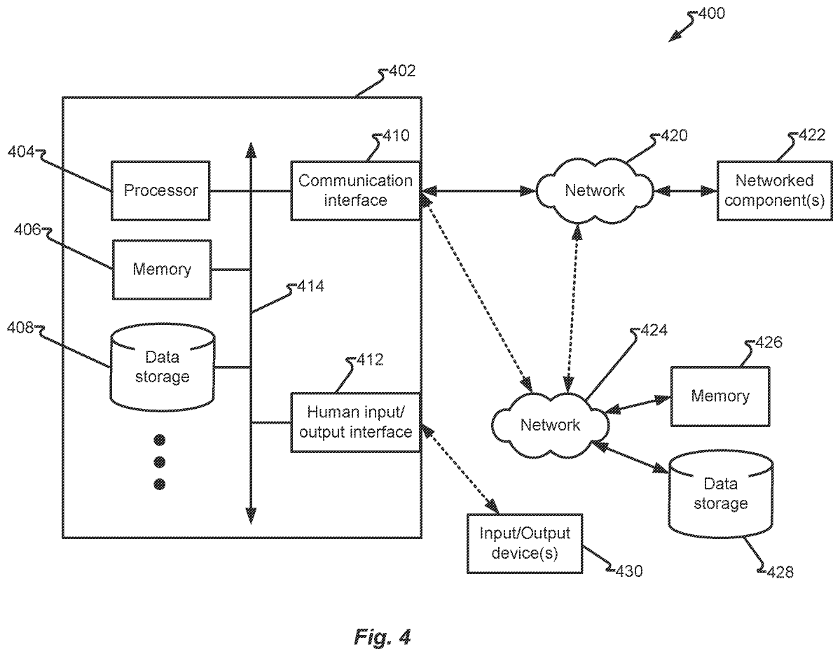

FIG. 4 depicts device 402 in system 400 in accordance with embodiments of the present disclosure. In one embodiment, processing logic 106 may be embodied, in whole or in part, as device 402 comprising various components and connections to other components and/or systems. The components are variously embodied and may comprise processor 404. The term “processor,” as used herein, refers exclusively to electronic hardware components comprising electrical circuitry with connections (e.g., pin-outs) to convey encoded electrical signals to and from the electrical circuitry. Processor 404 may be further embodied as a single electronic microprocessor or multiprocessor device (e.g., multicore) having electrical circuitry therein which may further comprise a control unit(s), input/output unit(s), arithmetic logic unit(s), register(s), primary memory, and/or other components that access information (e.g., data, instructions, etc.), such as received via bus 414, executes instructions, and outputs data, again such as via bus 414. In other embodiments, processor 404 may comprise a shared processing device that may be utilized by other processes and/or process owners, such as in a processing array within a system (e.g., blade, multi-processor board, etc.) or distributed processing system (e.g., “cloud”, farm, etc.). It should be appreciated that processor 404 is a non-transitory computing device (e.g., electronic machine comprising circuitry and connections to communicate with other components and devices). Processor 404 may operate a virtual processor, such as to process machine instructions not native to the processor (e.g., translate the VAX operating system and VAX machine instruction code set into Intel® 9xx chipset code to enable VAX-specific applications to execute on a virtual VAX processor). However, as those of ordinary skill understand, such virtual processors are applications executed by hardware, more specifically, the underlying electrical circuitry and other hardware of the processor (e.g., processor 404). Processor 404 may be executed by virtual processors, such as when applications (i.e., Pod) are orchestrated by Kubernetes. Virtual processors enable an application to be presented with what appears to be a static and/or dedicated processor executing the instructions of the application, while underlying non-virtual processor(s) are executing the instructions and may be dynamic and/or split among a number of processors.

In addition to the components of processor 404, device 402 may utilize memory 406 and/or data storage 408 for the storage of accessible data, such as instructions, values, etc. Communication interface 410 facilitates communication with components, such as processor 404 via bus 414 with components not accessible via bus 414. Communication interface 410 may be embodied as a network port, card, cable, or other configured hardware device. Additionally or alternatively, human input/output interface 412 connects to one or more interface components to receive and/or present information (e.g., instructions, data, values, etc.) to and/or from a human and/or electronic device. Examples of input/output devices 430 that may be connected to input/output interface include, but are not limited to, a keyboard, a mouse, a trackball, a printer, a display, a sensor, a switch, a relay, a speaker, a microphone, a still and/or video camera, etc. In another embodiment, communication interface 410 may comprise, or be comprised by, human input/output interface 412. Communication interface 410 may be configured to communicate directly with a networked component or utilize one or more networks, such as network 420 and/or network 424. Network 420 may be a wired network (e.g., Ethernet), wireless network (e.g., WiFi, Bluetooth, cellular, etc.), or combination thereof, and enable device 402 to communicate with networked component(s) 422. In other embodiments, network 420 may be embodied, in whole or in part, as a telephony network (e.g., public switched telephone network (PSTN), private branch exchange (PBX), cellular telephony network, etc.). Additionally or alternatively, one or more other networks may be utilized. For example, network 424 may represent a second network, which may facilitate communication with components utilized by device 402.

Components attached to network 424 may include memory 426, data storage 428, input/output device(s) 430, and/or other components that may be accessible to processor 404. For example, memory 426 and/or data storage 428 may supplement or supplant memory 406 and/or data storage 408 entirely or for a particular task or purpose. For example, memory 426 and/or data storage 428 may be an external data repository (e.g., server farm, array, “cloud,” etc.) and enable device 402, and/or other devices, to access data thereon. Similarly, input/output device(s) 430 may be accessed by processor 404 via human input/output interface 412 and/or via communication interface 410 either directly, via network 424, via network 420 alone (not shown), or via networks 424 and 420. Each of memory 406, data storage 408, memory 426, and data storage 428 comprise a non-transitory data storage comprising a data storage device.

It should be appreciated that computer readable data may be sent, received, stored, processed, and/or presented by a variety of components. It should also be appreciated that components illustrated may control other components, whether illustrated herein or otherwise. For example, one input/output device 430 may be a router, a switch, a port, or other communication component such that a particular output of processor 404 enables (or disables) input/output device 430, which may be associated with network 420 and/or network 424, to allow (or disallow) communications between two or more nodes on network 420 and/or network 424. One of ordinary skill in the art will appreciate that other communication equipment may be utilized, in addition or as an alternative, to those described herein without departing from the scope of the embodiments.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components and included, in one or more embodiments, voltages in memory circuits, configuration of switching circuits, and/or by selective use of particular logic gate circuits. Additionally or alternative, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), “cloud”, multi-purpose processor array(s), cluster(s), etc.) and/or may be co-located with a microprocessor performing other processing operations. Any one or more microprocessor may be integrated into a single processing appliance (e.g., computer, server, blade, etc.) or located entirely or in part in a discrete component connected via a communications link (e.g., bus, network, backplane, etc. or a plurality thereof).

Examples of general-purpose microprocessors may comprise, a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22 nm Haswell, Intel® Core® i5-3570K 22 nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARIV1926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein as provided by one or more processing components.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A system for automatic configuration optimization, comprising:
a first processing system;
a second processing system;
a configuration component to optimize a software application executing on the first processor system;
the configuration component causes the first processing system and the second processing system to each be provided with the software application and data, the data to be manipulated by each of the first processing system and the second processing system determined by the software application and values for a number of parameter values;
wherein the configuration component provides a first parameter value, of the number of parameter values, to each of the first processing system and second processing system;
wherein the first processing system, configured with the first parameter value, executes the software application and, therefrom, provides a first performance indicia to the configuration component;
wherein the second processing system, configured with a second parameter value that is different from the first parameter value, executes the software application and, therefrom, provides a second performance indicia to the configuration component; and
wherein the configuration component compares the first performance indicia to the second performance indicia and, upon determining that the second performance indicia indicates a performance improvement, configures the first processing system with the second parameter value.

2. The system of claim 1, wherein the first processing system comprises a production system and the second processing system comprises a test system.

3. The system of claim 1, wherein the first processing system utilizes the data maintained in a first database and the second processing system utilizes the data maintained in a second database and wherein the first database and the second database are synchronized.

4. The system of claim 1, wherein the first processing system and the second processing system are the same system configured and executed at a first time and a second time, respectively.

5. The system of claim 1, wherein the second parameter value comprises the first parameter value with an alteration comprising a randomly selected modification to at least one of the number of parameter values.

6. The system of claim 5, wherein the configuration component compares the first performance indicia to the second performance indicia and upon determining the second performance indicia indicates the performance improvement, configures the second processing system with an altered configuration.

7. The system of claim 1, wherein the second parameter value comprises the first parameter value with an alteration chosen by a neural network trained to select a change to at least one of the number of parameter values.

8. The system of claim 1, wherein the second parameter value comprises the first parameter value with an alteration chosen by a neural network trained to select changes to at least two of the number of parameter values, wherein a change to only one of the at least two of the number of parameter values does not improve performance of the second processing system.

9. The system of claim 1, wherein the second processing system comprises a plurality of second systems each having dissimilar parameter values from a remainder of the plurality of second systems.

10. The system of claim 9, wherein the configuration component, upon determining a first of the plurality of the second systems provide the second performance indicia indicating the performance improvement over a second of the plurality of second systems, configures the second of the plurality of second systems with parameter values of the first plurality of the second systems with at least one additional alteration to the parameter values.

11. A method for automatic configuration optimization, comprising:
causing a first processing system and a second processing system to each be provided with a software application and data, the data to be manipulated by each of the first processing system and the second processing system as determined by the software application, wherein each of the first processing system and second processing system comprises a number of parameter values utilized to execute the software application;
configuring the first processing system with a first parameter value of the number of parameter values;
configuring the second processing system with a second parameter value of the number of parameter values that is different from the first parameter value;
executing, the first processing system as configured with the first parameter value and obtaining, as a result, a first performance indicia;
executing, the second processing system as configured with the second parameter value and obtaining, as a result, a second performance indicia;
comparing the first performance indicia to the second performance indicia and, upon determining that the second performance indicia indicates a performance improvement, configuring the first processing system with the second parameter value.

12. The method of claim 11, wherein the first processing system comprises a production system and the second processing system comprises a test system.

13. The method of claim 11, wherein the first processing system utilizes the data maintained in a first database and the second processing system utilizes the data maintained in a second database and wherein the first database and the second database are synchronized.

14. The method of claim 11, wherein the first processing system and the second processing system are the same system configured and executed at a first time and a second time, respectively.

15. The method of claim 11, wherein the second parameter value comprises the first parameter value with an alteration comprising a randomly selected modification to at least one of the number of parameter values.

16. The method of claim 15, further comprising configuring the second processing system with an altered configuration upon determining the second performance indicia indicates the performance improvement.

17. The method of claim 11, wherein the second parameter value comprises the first parameter value with an alteration chosen by a neural network trained to select a change to at least one of the number of parameter values.

18. The method of claim 11, wherein the second parameter value comprises the first parameter value with an alteration chosen by a neural network trained to select changes to at least two of the number of parameter values, wherein a change to only one of the at least two of the number of parameter values does not improve performance of the second processing system.

19. The method of claim 11, wherein the second processing system comprises a plurality of second systems each having dissimilar parameter values from a remainder of the plurality of second systems.

20. A system, comprising:
means to cause a first processing system and a second processing system to each be provided with a software application and data, the data to be manipulated by each of the first processing system and the second processing system as determined by the software application, wherein each of the first processing system and second processing system comprises a number of parameter values utilized to execute the software application;
means to configure the first processing system with a first parameter value of the number of parameter values;
means to configure the second processing system with a second parameter value of the number of parameter values that is different from the first parameter value;
means to execute, the first processing system as configured with the first parameter value and obtaining, as a result, a first performance indicia;
means to execute, the second processing system as configured with the second parameter value and obtaining, as a result, a second performance indicia;
means to compare the first performance indicia to the second performance indicia and, upon determining that the second performance indicia indicates a performance improvement, configuring the first processing system with the second parameter value.
